(19) United States
(12) Patent Application Publication
(10) Pub. No.: US 2022/0138406 A1
(43) Pub. Date: May 5, 2022

(54) REVIEWING METHOD, INFORMATION PROCESSING DEVICE, AND REVIEWING PROGRAM

(71) Applicant: Nippon Telegraph and Telephone Corporation, Tokyo (JP)

(72) Inventors: Nana HASEGAWA, Musashino-shi, Tokyo (JP); Hiroshi MIYAO, Musashino-shi, Tokyo (JP); Tsunenari SAITO, Musashino-shi, Tokyo (JP)

(21) Appl. No.: 17/430,089

(22) PCT Filed: Jan. 31, 2020
(86) PCT No.: PCT/JP2020/003801

§ 371 Date: Aug. 11, 2021

(30) Foreign Application Priority Data
Feb. 14, 2019 (JP) 2019-024652

(51) Int. Cl. G06F 40/166; G06F 40/216; G06F 40/268

(52) U.S. Cl. CPC G06F 40/166; G06F 40/268; G06F 40/216

(57) ABSTRACT

An information processing device (10) extracts a pair of an abbreviation and an original term from text data; counts the number of appearances of each of the abbreviation and the original term of the pair; determines which is larger between the number of appearances of the abbreviation and the number of appearances of the original term; and stores a determination result into a determination table storage section (14a). Then, the information processing device (10) refers to the determination result stored in the determination table storage section (14a), determines whether the abbreviation or the original term determined to appear less frequently is included among terms included in proofreading-target text data, and, if determining that the abbreviation or the original term determined to appear less frequently is included, identifies the term as a correction-target term.

### TECHNICAL FIELD

The present invention relates to a proofreading method, an information processing device and a proofreading program.

### BACKGROUND ART

At development sites, abbreviations for development terms are often used. For example, “middle” for “middleware”, “repli” for “replication”, “tel num” for “telephone number” and the like are given as examples. Further, as for text data of a development document or the like, since the number of writers is not limited to one, expression variations may occur. As for such expression variations, it is necessary to unify the expression variations to any one expression, and, therefore, it has been conventionally performed to manually check and correct expression variations about development terms.

### CITATION LIST

### Non-Patent Literature

Non-Patent Literature 1: Hiroyuki Sakai and Shigeru Masuyama, “Improvement of the Method for Acquiring Knowledge from a Single Corpus on Correspondences between Abbreviations and Their Original words”, Natural Language Processing, Vol. 12, No. 5, October 2005

### SUMMARY OF THE INVENTION

### Technical Problem

In a conventional method, however, if expression variations occur in text data of a development document or the like, the text data is manually corrected, and, therefore, there is a problem that it takes much time and effort.

For example, which between an abbreviation and an original term is to be written varies depending on development sites and differs according to development terms. Therefore, it cannot be determined uniformly, and it is required to manually check and correct expression variations about development terms. Note that proofreading tools that are generally commercially available do not target technical terms like development terms, and expression variations about development terms are often manually checked and corrected.

### Means for Solving the Problem

In order to solve the problem described above and achieve the object, a proofreading method of the present invention is a proofreading method executed by an information processing device, the proofreading method including: an extraction process of extracting a pair of an abbreviation and an original term from text data; a counting process of counting the number of appearances of each of the abbreviation and the original term of the pair extracted by the extraction process, determining which is larger between the number of appearances of the abbreviation and the number of appearances of the original term, and storing a determination result into a storage unit; and a determination process of referring to the determination result stored in the storage unit, determining whether the abbreviation or the original term determined by the counting process to appear less frequently is included among terms included in proofreading-target text data, and, if determining that the abbreviation or the original term determined to appear less frequently is included, identifying the term as a correction-target term.

An information processing device of the present invention includes: an extraction unit extracting a pair of an abbreviation and an original term from text data; a counting unit counting the number of appearances of each of the abbreviation and the original term of the pair extracted by the extraction unit, determining which is larger between the number of appearances of the abbreviation and the number of appearances of the original term, and storing a determination result into a storage unit; and a determination unit referring to the determination result stored in the storage unit, determining whether the abbreviation or the original term determined by the counting unit to appear less frequently is included among terms included in proofreading-target text data, and, if determining that the abbreviation or the original term determined to appear less frequently is included, identifying the term as a correction-target term.

A proofreading program of the present invention causes a computer to execute: an extraction step of extracting a pair of an abbreviation and an original term from text data; a counting step of counting the number of appearances of each of the abbreviation and the original term of the pair extracted by the extraction step, determining which is larger between the number of appearances of the abbreviation and the number of appearances of the original term, and storing a determination result into a storage unit; and a determination step of referring to the determination result stored in the storage unit, determining whether the abbreviation or the original term determined by the counting step to appear less frequently is included among terms included in proofreading-target text data, and, if determining that the abbreviation or the original term determined to appear less frequently is included, identifying the term as a correction-target term.

### Effects of the Invention

According to the present invention, an effect is obtained that it is possible to reduce work for correcting text data including expression variations.

### BRIEF DESCRIPTION OF DRAWINGS

FIG. 1 is a block diagram showing a configuration example of an information processing device according to a first embodiment.

FIG. 2 is a diagram showing an example of data stored in a determination table storage section.

FIG. 3 is a diagram explaining a process of extracting pairs of an abbreviation and an original term.

FIG. 4 is a diagram explaining extraction rules.

FIG. 5 is a diagram explaining a process of counting the number of appearances of the abbreviation and the number of appearances of the original term of each pair.

FIG. 6 is a diagram explaining a process of correcting a new document.

FIG. 7 is a flowchart showing an example of a flow of a determination table storage process in the information processing device according to the first embodiment.

FIG. 8 is a flowchart showing an example of a flow of a proofreading process in the information processing device according to the first embodiment.

FIG. 9 is a diagram for explaining a background of a development document at a development site.

FIG. 10 is a diagram showing a computer to execute a proofreading program.

### DESCRIPTION OF EMBODIMENT

An embodiment of a proofreading method, an information processing device and a proofreading program according to the present application will be described below in detail based on drawings. Note that the proofreading method, the information processing device and the proofreading program according to the present application are not limited by this embodiment.

### First Embodiment

In the embodiment below, a configuration of an information processing device 10 according to the first embodiment and a flow of a process of the information processing device 10 will be described in that order, and effects of the first embodiment will be described last.

[Configuration of Information Processing Device]

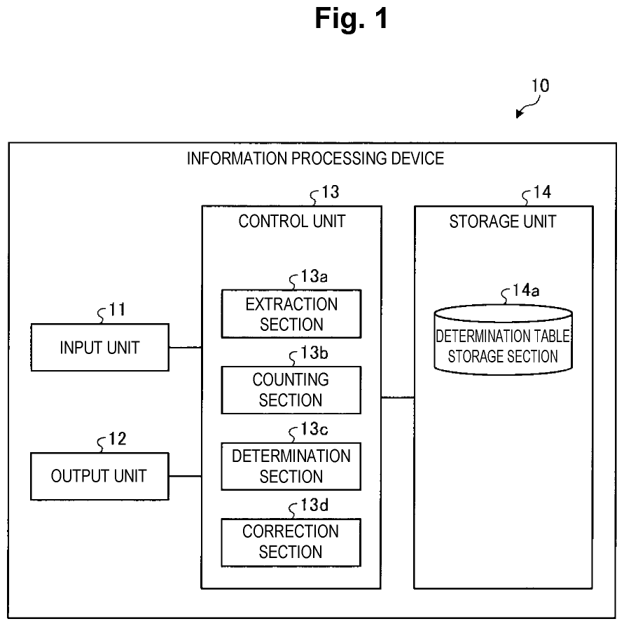

First, a configuration example of the information processing device 10 of the present embodiment will be described using FIG. 1. FIG. 1 is a block diagram showing a configuration example of the information processing device according to the first embodiment. The information processing device 10 illustrated in FIG. 1 creates a pair of an abbreviation and an original term from text data of a past development document, determines appearance frequency of each of the abbreviation and the original term, and sets whichever appears more frequently as a correct term and whichever appears less frequency as a wrong term. Then, if the wrong term is used in a proofreading-target new document, the information processing device 10 corrects the term to the correct term.

As shown in FIG. 1, the information processing device 10 has an input unit 11, an output unit 12, a control unit 13 and a storage unit 14. A process of each of the units the information processing device 10 has will be described below.

The input unit 11 is an input device such as a keyboard and a mouse and is for inputting, for example, text data of a past development document, proofreading-target text data and the like. The output unit 12 is an output device such as a display and outputs a proofreading result of proofreading-target text data, and the like. For example, the output unit 12 may be adapted to output a correction-target term identified by a determination section 13c described later. Note that the proofreading result may be transmitted to an external device instead of being outputted from the output unit 12.

The storage unit 14 stores data and a program required for various kinds of processes by the control unit 13. For example, the storage unit 14 is a semiconductor memory element, such as a RAM (random access memory) and a flash memory, a storage device such as a hard disk and an optical disk, or the like. For example, the storage unit 14 has a determination table storage section 14a.

For a pair of an abbreviation and an original term extracted from text data of a past development document, the determination table storage section 14a stores which is a correct term and which is a wrong term.

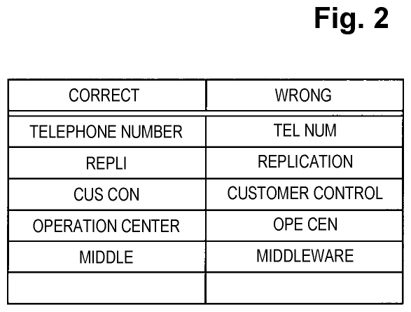

For example, as illustrated in FIG. 2, the determination table storage section 14a stores, for each pair of an abbreviation and an original term, “correct” indicating a correct term and “wrong” indicating being a wrong term in association with each other. FIG. 2 is a diagram showing an example of data stored in a determination table storage section. To make a description on the example in FIG. 2, for example, the determination table storage section 14a stores that “telephone number” which is an original term is a correct term, and “tel num” which is an abbreviation is a wrong term.

The control unit 13 has an internal memory for storing a program specifying various kinds of process procedures and the like, and required data, and executes various processes thereby. Here, the control unit 13 is, for example, an electronic circuit such as a CPU (central processing unit) and an MPU (micro processing unit), or an integrated circuit such as an ASIC (application specific integrated circuit) and an FPGA (field programmable gate array). The control unit 13 has an extraction section 13a, a counting section 13b, the determination section 13c and a correction section 13d.

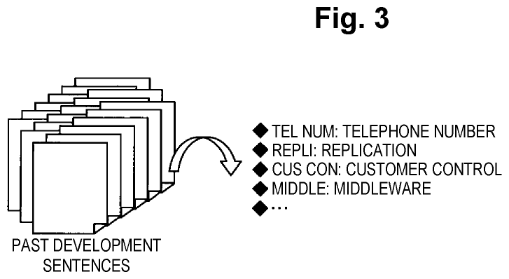

The extraction section 13a extracts pairs of an abbreviation and an original term from text data. For example, the extraction section 13a aggregates text data of past development documents at a particular development site to create a development corpus. Then, for example, as illustrated in FIG. 3, the extraction section 13a acquires pairs of an abbreviation and an original term from the text data of the past development documents according to extraction rules and lists up the pairs. FIG. 3 is a diagram explaining the process of extracting pairs of an abbreviation and an original term.

Note that, as for the text data of the past development documents, the extraction section 13a may aggregate text data of past development documents at a plurality of development sites. In this case, the extraction section 13a may extract pairs of an abbreviation and an original term from all the text data and list up the pairs or may classify the text data according to the development sites and, for each development site, extract pairs of an abbreviation and an original term and list up the pairs.

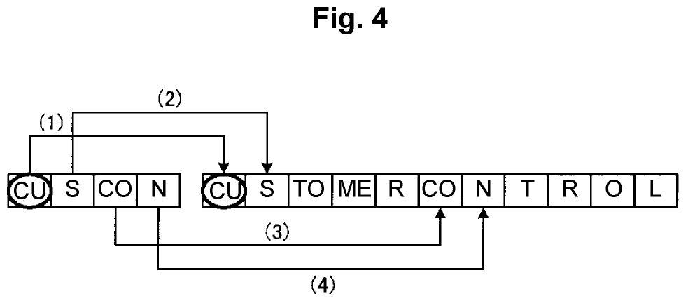

Here, the extraction rules will be described using FIG. 4. FIG. 4 is a diagram explaining the extraction rules. Rule 1 and Rule 2 below are set as the extraction rules, and the extraction section 13a extracts nouns that satisfy Rule 1 and Rule 2 as pairs of an abbreviation and an original term.

Rule 1: All characters included in a noun A appear in a noun B in the same order.

Rule 2: Top character strings of the noun A (a candidate for an abbreviation) and the noun B (a candidate for an original term) are the same.

If all the characters included in the noun A included in text data appear in the noun B included in the text data in the same order, and the top character strings of the noun A and the noun B are the same, the extraction section 13a extracts the noun A and the noun B as a pair in which the noun A is an abbreviation, and the noun B is an original term, according to the extraction rules.

To make a description using the example of FIG. 4, the extraction section 13a determines whether “cu”, “s”, “co”, and “n” included in a noun “cus con” appear in a noun “customer control” in the same order or not so as to determine whether the noun “cus con” and the noun “customer control” satisfy the extraction rules or not. Since “cu”, “s”, “co”, and “n” appear in that order in the noun “customer control”, the extraction section 13a determines that Rule 1 above is satisfied.

Next, the extraction section 13a determines whether the top characters of the noun “cus con” and the noun “customer control” are the same or not. Since the top characters of both of the noun “cus con” and the noun “customer control” are “cu”, the extraction section 13a determines that Rule 2 above is satisfied. As a result, since both of Rule 1 and Rule 2 are satisfied, the extraction section 13a acquires the noun “cus con” and the noun “customer control” as a candidate for an abbreviation and a candidate for an original term.

Then, the extraction section 13a calculates, for example, a degree of inter-noun similarity between the candidate for an abbreviation and the candidate for an original term by Word2vec. The extraction section 13a extracts such a pair that the degree of inter-noun similarity is a certain value as regular abbreviations and original terms.

The counting section 13b counts the number of appearances of each of the abbreviation and the original term of the pair extracted by the extraction section 13a, determines which is larger between the number of appearances of the abbreviation and the number of appearances of the original term, and stores a determination result into the determination table storage section 14a.

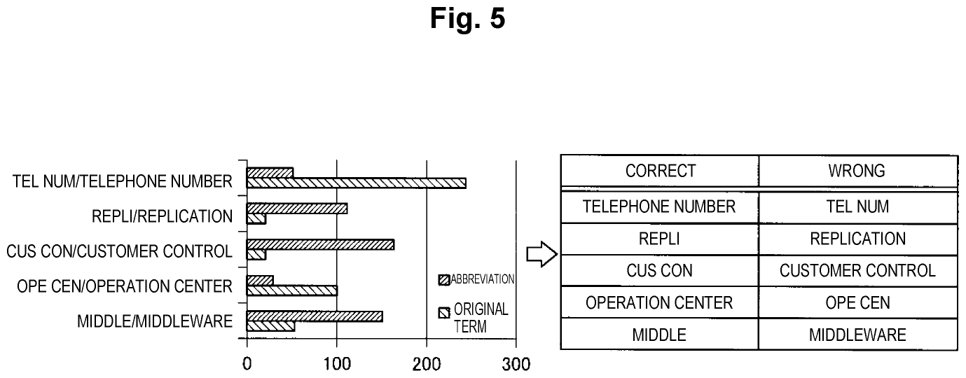

Here, a process of counting the number of appearances of an abbreviation and the number of appearances of an original term will be described with an example of FIG. 5. FIG. 5 is a diagram explaining the process of counting the number of appearances of an abbreviation and the number of appearances of an original term. As illustrated in FIG. 5, the counting section 13b counts the number of appearances of each of an abbreviation and an original term of each pair in text data of a past development document, and stores the abbreviation and the original term into the determination table storage section 14a, with whichever that appears more frequently as a correct term and whichever that appears less frequently as a wrong term.

To make a description on the example of FIG. 5 specifically, for example, the counting section 13b counts the number of appearances of each of the abbreviation “tel num” and the original term “telephone number”, and stores “telephone number” that appears more frequently as a correct term, and “tel num” that appears less frequently as a wrong term, into the determination table storage section 14a.

Note that, if the extraction section 13a extracts a pair of an abbreviation and an original term from text data of past development documents at a plurality of development sites, the counting section 13b may count the number of appearances of the abbreviation and the number of appearances of the original term in text data for each development site and store a determination result into the determination table storage section 14a for each development site.

The determination section 13c refers to the determination result stored in the determination table storage section 14a, determines whether an abbreviation or an original term determined by the counting section 13b to appear less frequently is included among terms included in the proofreading-target text data, and, if determining that an abbreviation or an original term determined by the counting section 13b to appear less frequently is included, identifies the term as a correction-target term.

For example, when accepting a new document as proofreading-target text data, the determination section 13c refers to a determination table and determines whether a term stored in the determination table as “wrong” is included in the new document or not. Then, if determining that a term stored in the determination table as “wrong” is included in the new document, the determination section 13c notifies the correction section 13d of the correction-target term. The determination section 13c may be adapted to output the correction-target term via the output unit 12b.

If the correction-target term identified by the determination section 13c is an abbreviation, the correction section 13d corrects the term to an original term corresponding to the abbreviation, and, if the correction-target term is an original term, corrects the term to an abbreviation corresponding to the original term.

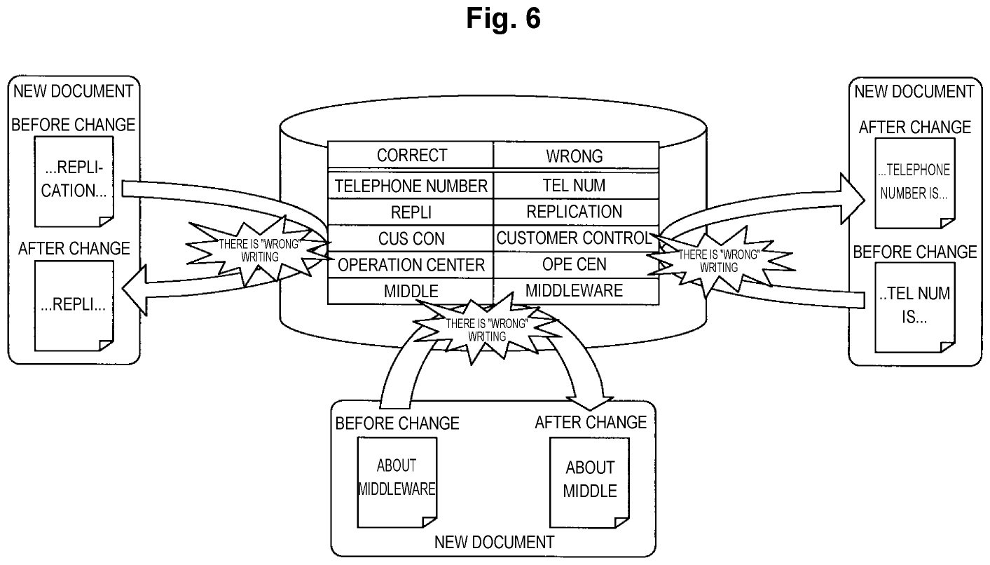

Here, a process of correcting proofreading-target text data will be described using FIG. 6. FIG. 6 is a diagram explaining a process of correcting a new document. In the example of FIG. 6, the information processing device 10 accepts input of a new document as proofreading-target text data. If a term corresponding to a term stored in the determination table storage section 14a as a wrong term is included in the new document, the information processing device 10 corrects the term in the new document to a correct term corresponding to the wrong term.

For example, to make a description using the example of FIG. 6, since “replication” in the new document corresponds to a wrong term “replication”, the correction section 13d corrects the “replication” to a correct term “repli”.

Thus, in the information processing device 10, it is possible to automatically determine which is more appropriate between writing an “abbreviation” and writing an “original term” in a new development document, and, if writing in the new development document is not appropriate, automatically correct the new development document or point out the mistake to a user. Note that the information processing device 10 may perform only a process of outputting a correction-target term identified by the determination section 13c and merely prompt the user to manually perform correction work, without performing the correction process by the correction section 13d.

[Process Procedure of Information Processing Device]

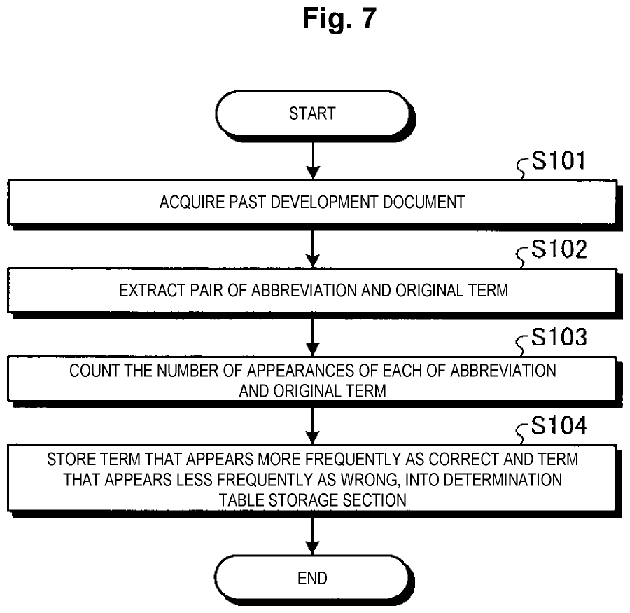

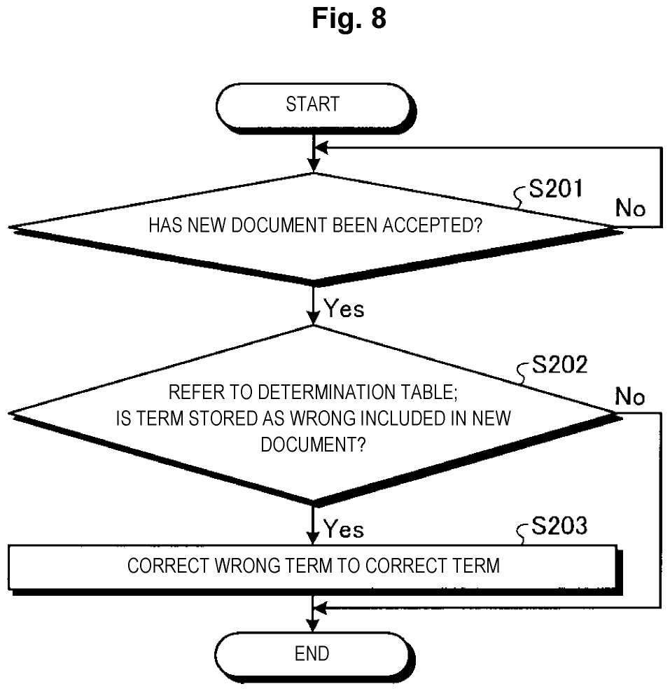

Next, an example of a process procedure by the information processing device 10 according to the first embodiment will be described, using FIGS. 7 and 8. FIG. 7 is a flowchart showing an example of a flow of a determination table storage process in the information processing device according to the first embodiment. FIG. 8 is a flowchart showing an example of a flow of a proofreading process in the information processing device according to the first embodiment.

First, a description will be made on a flow of a process of storing the determination table that shows which is a correct term and which is a wrong term between an abbreviation and a prototype of a pair, using FIG. 7. As illustrated in FIG. 7, the extraction section 13a of the information processing device 10 acquires a past development document (step S101) and extracts a pair of an abbreviation and an original term (step S102).

Then, the counting section 13b counts the number of appearances of each of the abbreviation and the original term of the pair extracted by the extraction section 13a (step S103), determines which is larger between the number of appearances of the abbreviation and the number of appearances of the original term, and stores a determination result into the determination table storage section 14a (step S104).

Next, a flow of a process of proofreading a new document using the determination table will be described using FIG. 8. As illustrated in FIG. 8, when accepting a new document as proofreading-target text data (step S201: Yes), the determination section 13c of the information processing device 10 refers to the determination table and determines whether a term stored in the determination table as “wrong” is included in the new document or not (step S202).

Then, if the determination section 13c determines that a term stored in the determination table as “wrong” is included in the new document (step S202: Yes), the correction section 13d notifies the correction section 13d of the correction-target term (step S203). If the determination section 13c determines that a term stored in the determination table as “wrong” is not included in the new document (step S202: No), the process is ended immediately.

[Effects of First Embodiment]

The information processing device 10 according to the first embodiment extracts a pair of an abbreviation and an original term from text data, counts the number of appearances of each of the abbreviation and the original term of the pair, determines which is larger between the number of appearances of the abbreviation and the number of appearances of the original term, and stores a determination result into the determination table storage section 14a. Then, the information processing device 10 refers to the determination result stored in the determination table storage section 14a, determines whether an abbreviation or an original term determined to appear less frequently is included among terms included in the proofreading-target text data, and, if determining that an abbreviation or an original term determined to appear less frequently is included, identify the term as a correction-target term. Therefore, the information processing device 10 can reduce work for correcting text data including expression variations.

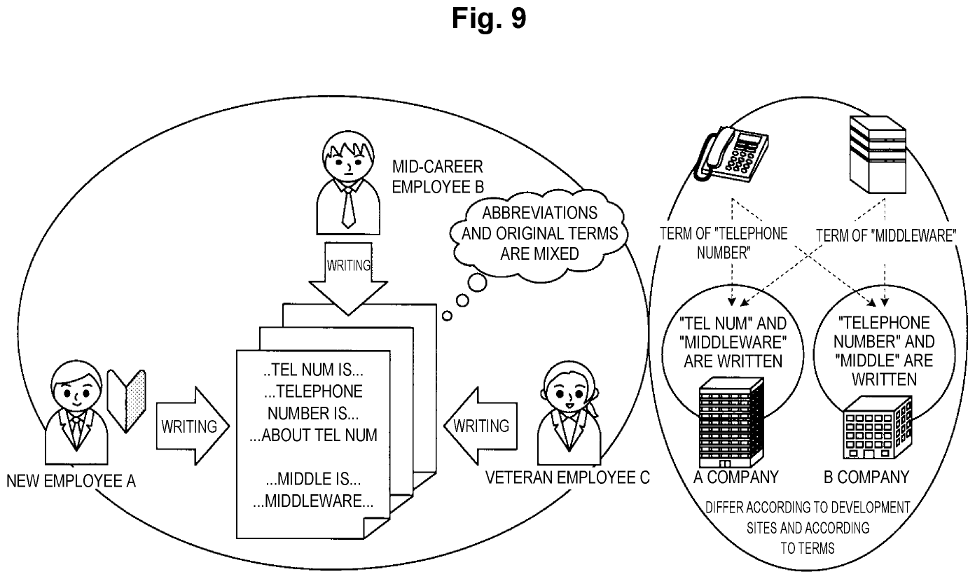

A background of a development document at a development site will be described using FIG. 9. FIG. 9 is a diagram for explaining the background of a development document at a development site. As illustrated in FIG. 9, in a case where a new employee A, a mid-career employee B and a veteran employee C create a development document as writers, abbreviations and original terms will be mixed together. Furthermore, whether an abbreviation or an original term is to be written differs according to development sites and according to terms. For example, as illustrated in FIG. 9, the abbreviation “tel num” is used for the term “telephone number”, and an original term “middleware” is used for middleware in a development document in A Company, while the abbreviation “tel num” is used for the term “telephone number”, and the original term “middleware” is used for middleware in a development document in B Company.

Under such an assumption, it is possible to, in the information processing device 10 according to the first embodiment, automatically determine which is more appropriate between writing an “abbreviation” and writing an “original term” in a new development document, and, when writing in the new development document is not appropriate, automatically correct the new development document or point out the mistake to the user. Therefore, in the information processing device 10 according to the first embodiment, it becomes possible to use an abbreviation or an original term according to a development environment, and it is possible to realize reduction of work for correction.

[System Configuration and the Like]

The components of the devices shown in the drawings are functionally conceptual and are not necessarily required to be physically configured as shown. In other words, specific forms of distribution/integration of the devices are not limited to those shown in the drawings, and all or a part of the devices can be configured being functionally or physically distributed/integrated in arbitrary units according to various kinds of loads and use situations. Furthermore, for processing functions performed in each device, all or an arbitrary part thereof can be realized by a CPU and a program analyzed and executed by the CPU or can be realized by hardware by a wired logic.

Further, among the processes described in the present embodiment, all or a part of a process described as being automatically performed can be manually performed, or all or a part of a process described as being manually performed can be automatically performed by a publicly known method. In addition, process procedures, control procedures, specific names, and information including various kinds of data and parameters shown in the above document and drawings can be arbitrarily changed unless otherwise stated.

[Program]

Further, it is also possible to create a program in which the processes executed by the information processing device, which have been described in the above embodiment, are written in a computer-executable language. For example, it is also possible to create a proofreading program in which the processes executed by the information processing device 10 according to the embodiment are written in a computer-executable language. In this case, by a computer executing the proofreading program, effects similar to the effects of the above embodiment can be obtained. Furthermore, by recording such a proofreading program to a computer-readable recording medium and causing the proofreading program recorded in the recording medium to be read into a computer and executing the proofreading program, processes similar to those of the above embodiment may be realized.

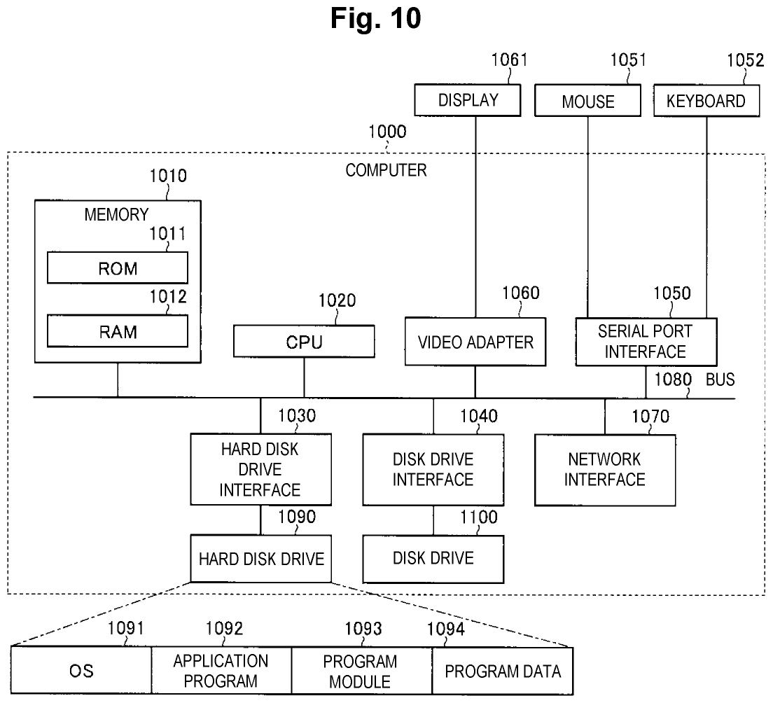

FIG. 10 is a diagram showing a computer to execute the proofreading program. As shown in FIG. 10, a computer 1000 has, for example, a memory 1010, a CPU 1020, a hard disk drive interface 1030, a disk drive interface 1040, a serial port interface 1050, a video adapter 1060 and a network interface 1070, and these units are connected via a bus 1080.

As illustrated in FIG. 10, the memory 1010 includes a ROM (read-only memory) 1011 and a RAM 1012. The ROM 1011 stores, for example a boot program such as BIOS (basic input/output system). As illustrate in FIG. 10, the hard disk drive interface 1030 is connected to a hard disk drive 1090. As illustrate in FIG. 10, the disk drive interface 1040 is connected to a disk drive 1100. For example, a removable storage medium such as a magnetic disk or an optical disk is inserted into the disk drive 1100. As illustrate in FIG. 10, the serial port interface 1050 is connected, for example, to a mouse 1110 and a keyboard 1120. As illustrate in FIG. 10, the video adapter 1060 is connected, for example, to a display 1130.

Here, as illustrate in FIG. 10, the hard disk drive 1090 stores, for example, an OS 1091, an application program 1092, a program module 1093 and program data 1094. In other words, the proofreading program described above is stored, for example, in the hard disk drive 1090 as a program module in which commands executed by the computer 1000 are written.

Further, the various kinds of data described in the above embodiment is stored, for example, in the memory 1010 or the hard disk drive 1090 as program data. Then, the CPU 1020 reads the program module 1093 and the program data 1094 stored in the memory 1010 or the hard disk drive 1090 onto the RAM 1012 as necessary and executes various processing procedures.

Note that the program module 1093 and the program data 1094 related to the proofreading program are not limited to the case of being stored in the hard disk drive 1090 but may be stored, for example, in a removable storage medium and read out by the CPU 1020 via the disk drive or the like. Or alternatively, the program module 1093 and the program data 1094 related to the proofreading program may be stored in another computer connected via a network (a LAN (local area network), a WAN (wide area network) or the like) and read out by the CPU 1020 via the network interface 1070.

### REFERENCE SIGNS LIST

10 Information processing device
11 Input unit
12 Output unit
13 Control unit
13a Extraction section
13b Counting section
13c Determination section
13d Correction section
14 Storage unit
14a Determination table storage section

1. A proofreading method executed by an information processing device, the proofreading method comprising:
an extraction process of extracting a pair of an abbreviation and an original term from text data;
a counting process of counting a number of appearances of each of the abbreviation and the original term of the pair extracted by the extraction process, determining which is larger between the number of appearances of the abbreviation and the number of appearances of the original term, and storing a determination result into a storage unit; and
a determination process of referring to the determination result stored in the storage unit, determining whether the abbreviation or the original term determined by the counting process to appear less frequently is included among terms included in proofreading-target text data, and, if determining that the abbreviation or the original term determined to appear less frequently is included, identifying the original term as a correction-target term.

2. The proofreading method according to claim 1, further comprising a correction process of, if the correction-target term identified by the determination process is the abbreviation, correcting the abbreviation to the original term corresponding to the abbreviation, and, if the correction-target term identified is the original term, correcting the original term to the abbreviation corresponding to the original term.

3. The proofreading method according to claim 1, further comprising an output process of outputting the correction-target term identified by the determination process.

4. The proofreading method according to claim 1, wherein, if all characters included in a first noun included in the text data appear in a second noun included in the text data in the same order, and top character strings of the first noun and the second noun are the same, the extraction process extracts the first noun and the second noun as a pair in which the first noun is an abbreviation, and the second noun is an original term.

5. An information processing device comprising:
an extraction unit, including one or more processors, configured to extract a pair of an abbreviation and an original term from text data;
a counting unit, including one or more processors, configured to count a number of appearances of each of the abbreviation and the original term of the pair extracted by the extraction unit, determine which is larger between the number of appearances of the abbreviation and the number of appearances of the original term, and store a determination result into a storage unit; and
a determination unit, including one or more processors, configured to refer to the determination result stored in the storage unit, determine whether the abbreviation or the original term determined by the counting unit to appear less frequently is included among terms included in proofreading-target text data, and, if determining that the abbreviation or the original term determined to appear less frequently is included, identify the original term as a correction-target term.

6. A non-transitory computer readable medium storing one or more instructions causing a computer to execute:
an extraction step of extracting a pair of an abbreviation and an original term from text data;
a counting step of counting a number of appearances of each of the abbreviation and the original term of the pair extracted by the extraction step, determining which is larger between the number of appearances of the abbreviation and the number of appearances of the original term, and storing a determination result into a storage unit; and
a determination step of referring to the determination result stored in the storage unit, determining whether the abbreviation or the original term determined by the counting step to appear less frequently is included among terms included in proofreading-target text data, and, if determining that the abbreviation or the original term determined to appear less frequently is included, identifying the original term as a correction-target term.

7. The information processing device according to claim 5, further comprising:
a correction unit, including one or more processors, configured to, if the correction-target term identified by the determination unit is the abbreviation, correct the abbreviation to the original term corresponding to the abbreviation, and, if the correction-target term identified is the original term, correct the original term to the abbreviation corresponding to the original term.

8. The information processing device according to claim 5, further comprising:
an output unit, including one or more processors, configured to output the correction-target term identified by the determination unit.

9. The information processing device according to claim 5, wherein, if all characters included in a first noun included in the text data appear in a second noun included in the text data in the same order, and top character strings of the first noun and the second noun are the same, the extraction unit is configured to extract the first noun and the second noun as a pair in which the first noun is an abbreviation, and the second noun is an original term.

10. The non-transitory computer readable medium according to claim 6, wherein the one or more instructions further cause the computer to execute:
a correction process of, if the correction-target term identified by the determination step is the abbreviation, correcting the abbreviation to the original term corresponding to the abbreviation, and, if the correction-target term identified is the original term, correcting the original term to the abbreviation corresponding to the original term.

11. The non-transitory computer readable medium according to claim 6, wherein the one or more instructions further cause the computer to execute:
an output process of outputting the correction-target term identified by the determination step.

12. The non-transitory computer readable medium according to claim 6, wherein, if all characters included in a first noun included in the text data appear in a second noun included in the text data in the same order, and top character strings of the first noun and the second noun are the same, the extraction step extracts the first noun and the second noun as a pair in which the first noun is an abbreviation, and the second noun is an original term.
